(19) United States
(12) Patent Application Publication
(10) Pub. No.: US 2006/0011619 A1
(43) Pub. Date: Jan. 19, 2006

(54) Heating element

(76) Inventor: Linda D. Sheridan, Grass Valley, CA (US)

Correspondence Address: MCDONOUGH, HOLLAND & ALLEN, 555 CAPITOL MALL, 9TH FLOOR, SACRAMENTO, CA, 95814, US

(21) Appl. No.: 10/892,508

(22) Filed: Jul. 14, 2004

(51) Int. Cl. H05B 6/80

(52) U.S. Cl. 219/730; 219/528

(57) ABSTRACT

The invention provides a warmer for heating a dining plate from beneath, said plate having a ridge on its lower surface for resting on a supporting surface, wherein said warmer comprises a heat absorbing material, and wherein when said plate is set on said warmer said heat absorbing material contacts a substantial portion of the lower surface of said plate interior to said supporting ridge.

### BACKGROUND OF THE INVENTION

1. Field of the Invention

This invention relates to the field of microwave warming elements.

2. Description of Related Art

It is known to warm a dinnerware plate before hot food is placed onto it. The most convenient means of heating anything in the modern household is by microwave radiation. However, dinnerware is generally manufactured so as not to absorb microwave radiation, for the reason of the common practice of reheating food in non-reactive, or “microwave safe” containers.

Microwave elements are know which will absorb heat from microwave radiation and then impart the heat to adjacent food or other materials by heat radiation. U.S. Pat. No. 5,871,527, to Gubernick, Feb. 16, 1999, discloses a microwaveable mixture and heating pad designed to be heated by microwave energy, and also discloses a container that can inwardly contain the mixture. The mixture comprises a starch material coating a salt to thereby maximize the speed and efficiency of heat transfer between the two materials.

U.S. Pat. No. 5,630,961, Salee, May 20, 1997, similarly discloses a microwave-activated mixed-powder that can be incorporated into a thermal storage material when activated by exposure to microwave energy.

U.S. Pat. No. 4,743,726, Hughes, et al., May 10, 1988, discloses a microwave activated heating element that includes a water saturated cellular core, water, heat and flame resistant rubber coated with high temperature lubricant, and a wax center core to absorb and store heat from the microwave heated water and rubber, for appliances utilizing radiant heat, such as, hair rollers and hair wavers, food warmers, heating pads, massagers, and other small household, medical and commercial devices.

U.S. Pat. No. 5,144,107, Peleg, Sep. 1, 1992, discloses a microwave susceptor sheet stock with heat control comprising a thin paperboard sheet having a microwave reactive layer and a graybody layer so that heat created by the interactive stratum will be absorbed and available from the graybody layer to heat a food product.

U.S. Pat. No. 5,049,714, Beresniewicz, et al., Sep. 17, 1991, discloses a non-melting film for use in packaging food for microwave cooking. The film is composed of a multilayer structure of film susceptible to melting when used in conjunction with a microwave susceptor, a layer of microwave susceptor material, and a layer formed from a crosslinked melt extrudable material that does not melt when used in a microwave oven.

GB2296319A, Nicols, published Jun. 26, 1996, discloses warming pads for use in warming dinnerware. The pads are heated either alone or already interleaved between pieces of dinnerware, i.e., in a stack of dinnerware with interleaved pads then placed in the microwave oven. The pads then become heated by the radiation and thus impart their heat in turn to the pieces of dinnerware. When needed, the dinnerware is removed from the stack and either directly used for holding food, or set out at a table while warm.

Current warming elements are not practical for use in heating food during the dining experience, as the dinnerware itself will not absorb microwave radiation, and a pad for warming a plate only imparts warmth to adjacent dinnerware while it is pre-heating in a stack. As most dinnerware is equally not good at retaining heat, unless the plates are used immediately after contact with the warming elements, there is a rapid loss of heat by transfer to the environment.

No prior art designs have a demonstrated a means for absorbing heat from a microwave and using it to radiate warmth directly to the food for an extended period of time, or during the dining experience.

There remains, then, a need for a heating element that can be heated simply and used to maintain the temperature of a meal on a plate for an extended period of time to allow the dining experience to be concluded.

### SUMMARY OF THE INVENTION

The invention provides a temperature regulating pad for a piece of dinnerware, the dinnerware having a lower surface with a recessed region formed therein. The pad comprises a heat absorbing material and is sized such that when the dinnerware is set over the pad on a supporting surface, the pad contacts a substantial portion of the lower surface of the dinnerware within the recessed region.

The dinnerware preferably has a generally flat lower surface, such as is formed in dinnerware plates where the lower surface has a ridge for resting on a supporting surface, and where the pad is sized to fit within the recessed region and against the lower surface of the dinnerware that is defined as being within the supporting ridge.

In an alternative embodiment, the pad is sized a little larger, and while it has a portion that will fit within the supporting ridge it further has a recessed groove on its upper surface for stably receiving the supporting ridge, i.e., the groove is sized to complement the supporting ridge at the bottom of the dinnerware piece.

The temperature regulating feature preferably means that the pad may be either cooled prior to contacting the dinnerware, whereby heat is transported away from the lower surface of the dinnerware, or heated prior to contacting the dinnerware, whereby heat is transported to the lower surface of the dinnerware.

In construction, the pad preferably comprises a heat absorbing material that can be heated in a microwave oven. In a further preferred embodiment the pad comprises a heat reflective material and/or a heat conductive material. In practice, these materials are provided in layers, with the heat conductive material disposed in practice against the lower surface of the dinnerware piece, and the heat reflective material against the supporting surface, such as a table or tray.

In a most preferred embodiment, the heat conductive material, the heat absorbing material and the heat reflective material form adjacent layers of the pad sealed at the edges.

The invention also provides a method for modifying the temperature of dinnerware by setting the dinnerware over a temperature regulating pad having a heat absorbing material, whereby the pad contacts a substantial portion of the lower surface of the dinnerware within the recessed region.

The invention further provides a dining set comprising a piece of dinnerware and a pad for regulating the temperature of the dinnerware, wherein the dinnerware comprises a lower surface having a recessed region formed therein, wherein the pad comprises a heat absorbing material, and wherein the pad is sized so that when the dinnerware is set over the pad on a supporting surface, the pad contacts a substantial portion of the lower surface of the dinnerware within the recessed region. In a more preferred embodiment, such a set comprises a series of dinnerware and pad sets sold as a dinnerware service.

These and other features and advantages of this invention are described in, or are apparent from, the following detailed description of various exemplary embodiments of the apparatus and methods according to this invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various exemplary embodiments of this invention will be described in detail, with reference to the following figures, wherein:

FIG. 1 of the accompanying drawings is a view of a dinnerware plate and a circular warming pad of the invention.

FIG. 2 of the accompanying drawings is a partial cut-away view of a dinnerware plate set on an alternative circular warming pad of the invention.

FIG. 3 of the accompanying drawings shows an exploded view of one embodiment of the warming pad of the invention.

FIG. 4 of the accompanying drawings is a partial cut-away view of an alternative warming pad supporting a dinnerware serving platter.

FIG. 5 of the accompanying drawings is a partial cut-away view of a dinnerware serving platter having an oval warming pad of the invention.

FIG. 6 of the accompanying drawings is a partial cut-away view of a dinnerware bowl showing a square warming pad of the invention.

### DETAILED DESCRIPTION OF THE PREFERRED EMBODIMENT

Reference shall now be made in detail to the present preferred embodiments of the invention, examples of which are illustrated in the figures accompanying this application. Wherever possible the same reference numbers will be used throughout the drawings to refer to the same or like parts.

The invention provides a temperature regulating pad 10 for warming or cooling a piece of dinnerware 11 while it is in service, i.e., at the time of dining.

By dinnerware 11 is meant any piece of dinnerware having a lower surface 12 with a recessed region 13 formed therein. Thus, dinnerware includes any of plates, bowls, saucers, cups, compartmentalized trays, platters or other dinnerware, and similar items, regardless of size or configuration, from which food is consumed or served.

Dinnerware often comes as a set of dishes and or other or various plates, platters and bowls, which are produced of a similar material in a similar style. Common dinnerware materials include china, porcelain, ceramic, certain plastics, metals and ceramic, stainless steel, glass, plastic, acrylic and porcelain stoneware. Most of these materials are naturally conductive and not insulating against the transfer of heat.

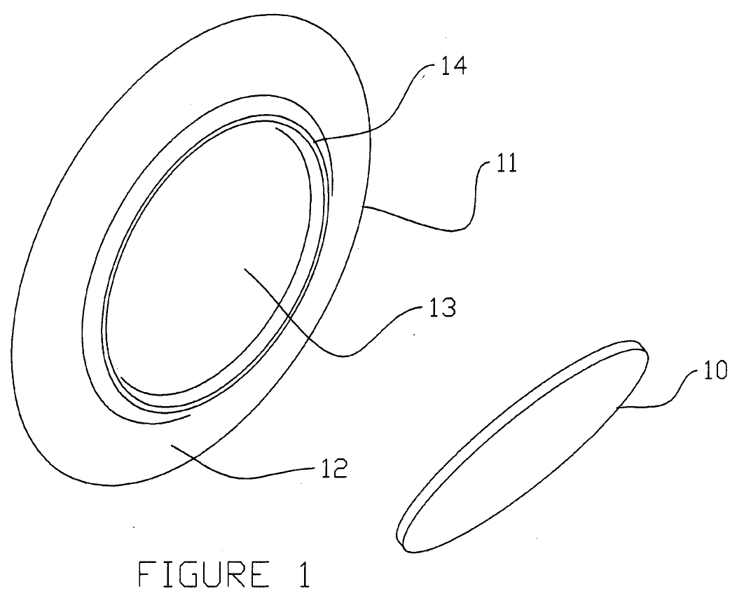

As seen now more particularly with reference to FIG. 1 the dinnerware 11 for use with the pad 10 preferably has a generally flat lower surface 12. A recessed region 13 for the pad 10 is formed in dinnerware plates at the lower surface. Many manufacturers of dinnerware have designed their products to have a ridge 14 formed in the lower surface, which is used for resting the dinnerware piece 11, for instance a dining plate, on the supporting surface, e.g., a table, tray or the like. This naturally forms the recessed region 13 in the lower surface of the dinnerware, which in such a design will be that lower surface of the dinnerware within the supporting ridge 14. In such cases the pad 10 may be sized to fit within an existing dinnerware construction, by matching the recessed region 13 of the lower surface 12 of the dinnerware that is within the supporting ridge 14. These recessed areas are generally on the order of about 160 mm or smaller, in some cases as little as 120 mm or less.

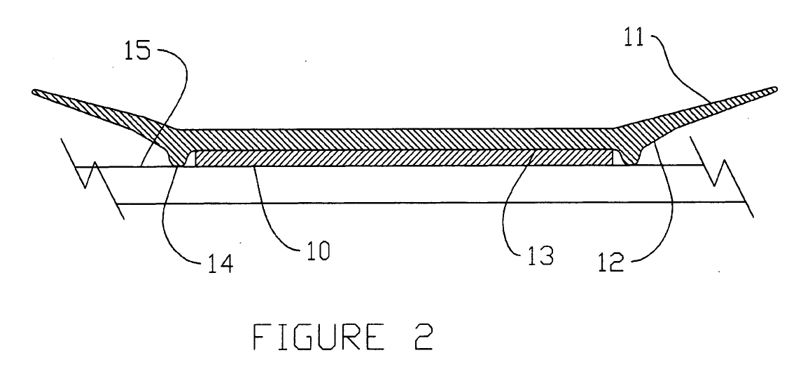

Alternatively, the pad 10 and the dinnerware 11 may be designed together to be sold as a set, whereon any size or shape of recess region 13 and pad 10 may be adopted that is convenient. As seen now in reference to FIG. 2, such a dining set comprises a piece of dinnerware and a pad sized so that when the dinnerware is set over the pad on a supporting surface 15, the pad 10 contacts a substantial portion of the lower surface 12 of the dinnerware within the recessed region 13. Such a set may comprise a series of dinnerware and pad sets sold as a part of a dinnerware service.

The pad 10 shown in FIG. 1 and FIG. 2 is adapted specifically for dinnerware having a generally flat lower surface with the recessed region formed therein. When the dinnerware 11 is set over the pad 10 it contacts a substantial portion of the lower surface of the dinnerware within the recessed region 13. The pad 10 may be either cooled prior to contacting the dinnerware 11, whereby heat is transported away from the lower surface 12 of the dinnerware, or heated prior to contacting the dinnerware 11, whereby heat is transported to the lower surface 12 of the dinnerware.

The pad 10 is temperature regulating, by which is meant that a pad will include a heat absorbing material that can be used in a method for modifying the temperature of dinnerware by setting the dinnerware over a temperature regulating pad having a heat absorbing material, whereby the pad contacts a substantial portion of the lower surface of the dinnerware within the recessed region. By heat absorbing material is meant any material capable of absorbing and then transporting heat to an adjacent dinnerware piece 11.

By heat transportation is meant any of the physical processes that are described by the words radiation, convection, and conduction. All involve the transportation of heat energy. The difference between these processes is that each is associated with a particular type of medium and therefore a particular mode of heat transportation. Convection involves the transportation of heat through fluids (either liquids or gases), whereas conduction involves the transportation of heat through solids.

Radiation involves the transportation of heat through empty space, or the vacuum. Any warm or hot object gives off infrared electromagnetic radiation, which can be absorbed in another object, heating it up.

Heat energy may be transported from a heated pad to a dinnerware by any of the above mechanisms, or, conversely, a chilled pad may be used to transport heat away from a dinnerware. In saying that heat is transported, it is understood that this includes a transfer of heat away from or to the dinnerware, and it is understood that the same mechanism is simultaneously by similar mechanisms, either directly or indirectly, transporting heat to or away from the dinnerware and any food placed therein.

Thusly, a heat absorbing material is any that may be heated or chilled relative to the ambient temperature and subsequently used to heat or draw heat from an adjacent dinnerware piece. Preferably the material will be capable of doing both, in alternative usages.

Many multi purpose materials are know which can be heated and used as a hot pad, or alternatively chilled, such as by placing in a freezer, and then used as a cold pad. The use of such materials in the construction of the warming pads is contemplated. Preferred are those materials that can be heated by being placed in a microwave oven, though materials capable of also being heated in a conventional oven are also contemplated.

Preferred pads 10 are those having heat absorbing materials especially adapted to become heated by microwave radiation, and which then release the retained heat back to the environment. Solid, liquid and powdered materials are known which have this capability.

In one such example, the pads may comprise a sealed bag made of polypropylene or PVC, containing an aqueous medium such as a glycol or gel polymer which has been hydrated. Examples of a such arrangements of materials are well known to the art, and are used throughout the industry.

In a further preferred embodiment the pad comprises a heat reflective material and/or a heat conductive material.

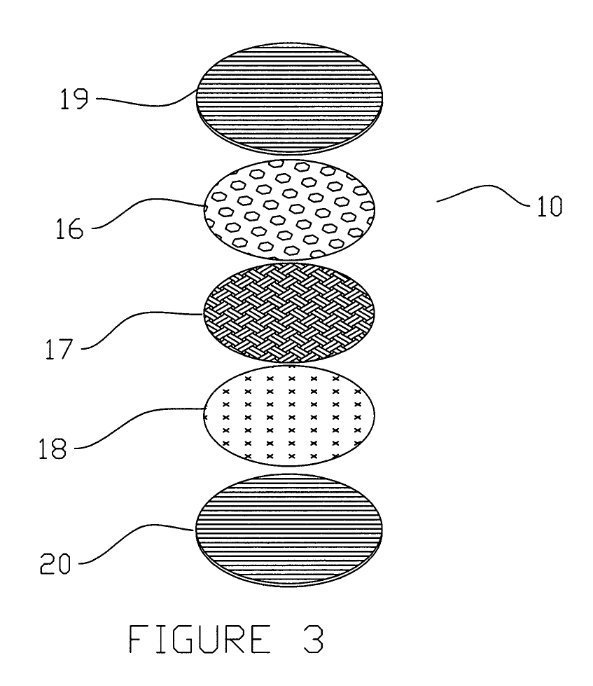

As seen in reference to FIG. 3, showing an exploded view of a temperature regulating pad 10, to facilitate heat transfer the pad may include a layer of heat conductive material 16 above the layer of heat absorbing material 17, such as to be disposed between the pad 10 and the dinnerware. Many heat conducting materials are know to the art that would be suitable, including cloth, or materials of conductive metal.

Similarly, a layer of heat reflective material 18 may be constructed into the pad 10. Such a material would be add as a layer disposed below the heat absorbing material, such that it will be away from the dinnerware. Such a material may include heat reflective metals or non-conducting materials that will not draw or conduct heat between the pad 10 and the supporting surface.

As will be evident, these materials are preferably provided in layers, with the heat conductive material 16 disposed as a layer opposite the heat reflective material1 18 with respect to the heat absorbing material 17. In practice the conductive material would be set closest to and in heat conducting relationship with the lower surface of a dinnerware piece, and the heat reflective material set against the supporting surface, such as a table or tray.

The heat conductive material, the heat absorbing material and the heat reflective material are most conveniently provided as adjacent layers of a pad sealed along the edges. In one alternative, a finishing material, such as a fabric, may be used to encapsulate the materials, optionally including an upper finished layer 19 and lower finished layer 20 above and below, respectively, the layer of heat conductive material 16 and layer of heat reflective material 18. Alternatively, the heat conductive material 16 may comprise the finished layer 19, and, the heat reflective material 18 may comprise the lower finished layer 20.

As seen in FIG. 1 and FIG. 2, the pads 10 can be simply sized to fit within dinnerware recess 13, so for the common dinnerware plates the construction of the pads will be thin and round. Depending on the materials, the pads 10 will be on the order of about 5 mm or less in thickness, and about 160 mm or less in diameter. In any case, the pads are preferably manufactured so that in use the pad 10 is in contact with a substantial portion of the inner recessed region 13 of the lower surface 12 of the dinnerware 11. By this it is meant that the recessed portion 13 is in physical contact with the outer material of the pad over at least about seventy-five percent or greater of the surface of the recessed region 13, preferably about ninety percent or greater, and most preferably about ninety-five percent or greater.

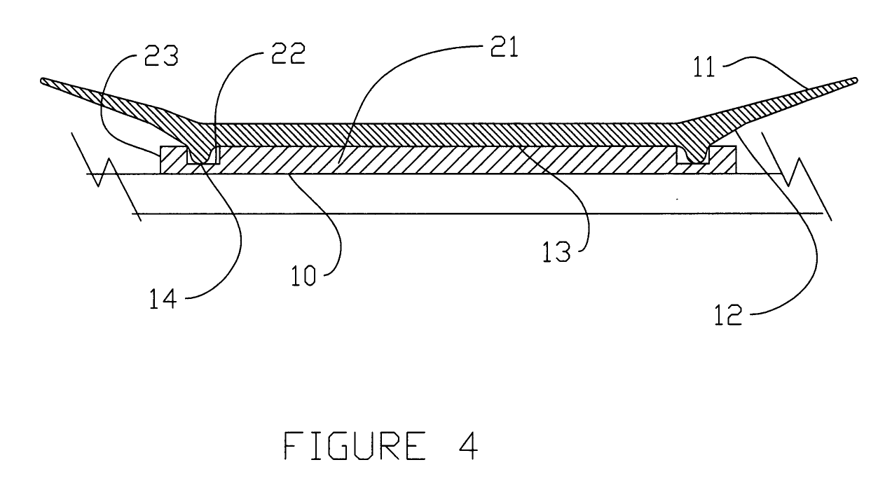

As seen now in reference to FIG. 4, in one alternative embodiment, the pad 10 is sized a little larger than the recessed region, and while it comprises an inner portion 21 that will fit within the supporting ridge it further comprises a recessed groove 22 on its upper surface for stably receiving the supporting ridge 14, i.e., the groove 22 is sized to complement the dimensions of the supporting ridge 14 found at the bottom surface 12 of the dinnerware piece 11. Extending beyond this groove is additionally material 24 that serves to further stabilize the plate on the pad.

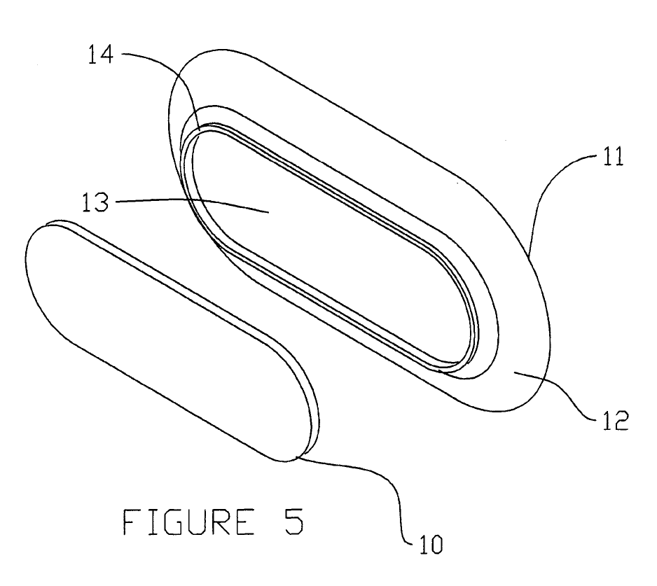

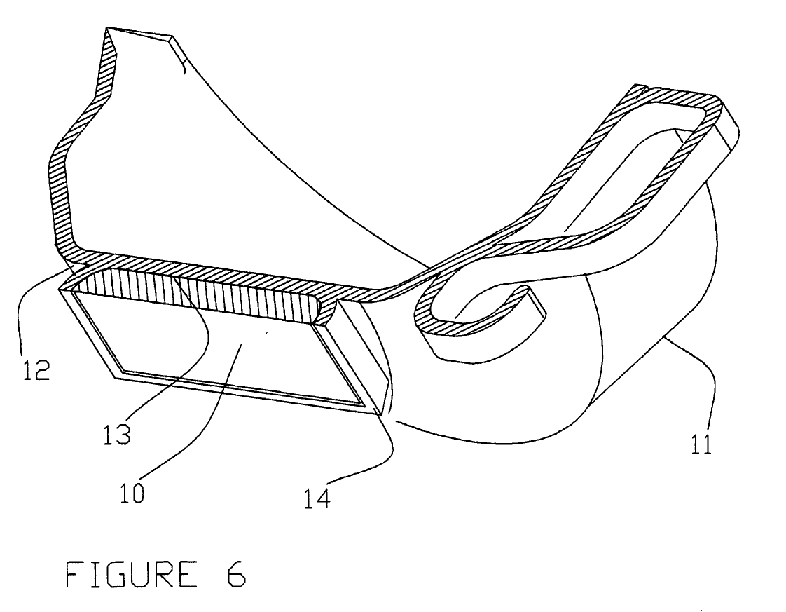

Depending on the dinnerware 11, however, the pads may be square, rectangular or other geometric shapes corresponding to the shapes of the dinnerware 11, more precisely, the shapes formed into a recessed area 13 on the lower surface 12 of the dinnerware 11. FIG. 5 and FIG. 6 demonstrate the application of temperature regulating pads in oval and square embodiments for, respectively, a serving platter and a gravy boat application.

FIG. 6 further demonstrates an alternative wherein the thickness of the pad is increased to fill a larger recessed area, such as may be found in a serving bowl piece of a dinnerware set, such as a gravy boat.

In a further alternative embodiment, the pad, 10 may be manufactured so as to be secured within the recessed region 13, either temporarily of permanently. For instance, the pad 10 may be sealed within the recessed region 13 with the same material as is used in forming the dinnerware 11, or, alternatively, with a different material, which may form a permanent or temporary seal of the pad 10 within the recessed region 13. In such an embodiment, the dinnerware 11 itself may be heated or chilled, as desired, prior to using the dinnerware 11 in serving a meal.

Although the foregoing invention has been described in some detail by way of illustration and example for purposes of clarity and understanding, it will be obvious that certain changes and modifications may be practiced within the scope of the invention, as limited only by the scope of the appended claims.

1. A temperature regulating pad for a piece of dinnerware, said dinnerware having a lower surface with a recessed region formed therein,
wherein said pad comprises a heat absorbing material,
wherein said pad is separably heatable from said dinnerware, and
wherein said pad is sized so that when said dinnerware is set over said pad on a supporting surface said pad contacts a substantial portion of the lower surface of said dinnerware within said recessed region.

2. The pad of claim 1 wherein said lower surface is generally flat.

3. The pad of claim 1 wherein said pad is adapted to be cooled prior to contacting said dinnerware whereby heat is transported away from said lower surface of said dinnerware.

4. The pad of claim 1 wherein said pad is adapted to be heated prior to contacting said dinnerware whereby heat is transported to said lower surface of said dinnerware.

5. The pad of claim 1 wherein said pad comprises a heat absorbing material.

6. The pad of claim 5 wherein said pad can be heated in a microwave oven.

7. The pad of claim 5 wherein said pad further comprises a heat reflective material.

8. The pad of claim 5 wherein said pad further comprises a heat conductive material.

9. The pad of claim 8 wherein said heat conductive material and said heat absorbing material form adjacent layers of said pad sealed at the edges.

10. The pad of claim 1 wherein said lower surface has a ridge for resting on a supporting surface, and wherein said recessed region comprises the lower surface of said dinnerware within said supporting ridge.

11. The pad of claim 10 wherein said pad is sized to fit within said supporting ridge.

12. The pad of claim 10 wherein said pad further comprises a recessed groove on its upper surface for stably receiving said supporting ridge.

13. The pad of claim 12 wherein said groove is sized to complement said supporting ridge.

14. A method for modifying the temperature of dinnerware, said dinnerware having a lower surface with a recessed region formed therein, wherein said method comprises setting the dinnerware over a temperature regulating pad having a heat absorbing material and being separably heatable from said dinnerware, whereby said pad contacts a substantial portion of the lower surface of said dinnerware within said recessed region.

15. The method of claim 14 wherein said lower surface is generally flat.

16. The method of claim 14 wherein said pad is placed on a supporting surface and wherein said dinnerware is placed over said pad.

17. The method of claim 14 wherein when said pad is cooled prior to contacting said dinnerware whereby heat is transported away from said lower surface of said dinnerware.

18. The method of claim 14 wherein when said pad is heated prior to contacting said dinnerware whereby heat is transported to said lower surface of said dinnerware.

19. The method of claim 14 wherein said pad comprises a heat absorbing material.

20. The method of claim 19 wherein said pad can be heated in a microwave oven.

21. The method of claim 19 wherein said pad further comprises a heat reflective material.

22. The method of claim 19 wherein said pad further comprises a heat conductive material.

23. The method of claim 22 wherein said heat conductive material and said heat absorbing material form adjacent layers of said pad sealed at the edges.

24. The method of claim 14 wherein said lower surface has a ridge for resting on a supporting surface, and wherein said recessed region comprises the lower surface of said dinnerware within said supporting ridge.

25. The method of claim 24 wherein said pad is sized to fit within said supporting ridge.

26. The method of claim 24 wherein said pad further comprises a recessed groove on its upper surface for stably receiving said supporting ridge.

27. The method of claim 26 wherein said groove is sized to complement said supporting ridge.

28. A dining set comprising a piece of dinnerware and a pad for regulating the temperature of said dinnerware,
wherein said dinnerware comprises a lower surface having a recessed region formed therein,
wherein said pad comprises a heat absorbing material,
wherein said pad is separably heatable from said dinnerware,
and wherein said pad is sized so that when said dinnerware is set over said pad on a supporting surface, said pad contacts a substantial portion of the lower surface of said dinnerware within said recessed region.

29. The set of claim 28 wherein said lower surface is generally flat.

30. The set of claim 28 further comprising a plurality of dinnerware and pad sets.

31. The set of claim 28 wherein said pad is adapted to be cooled prior to contacting said dinnerware whereby heat is transported away from said lower surface of said dinnerware.

32. The set of claim 28 wherein said pad is adapted to be heated prior to contacting said dinnerware whereby heat is transported to said lower surface of said dinnerware.

33. The set of claim 28 wherein said pad comprises a heat absorbing material.

34. The set of claim 33 wherein said pad can be heated in a microwave oven.

35. The set of claim 33 wherein said pad further comprises a heat reflective material.

36. The set of claim 33 wherein said pad further comprises a heat conductive material.

37. The set of claim 36 wherein said heat conductive material and said heat absorbing material form adjacent layers of said pad sealed at the edges.

38. The set of claim 28 wherein said lower surface has a ridge for resting on a supporting surface, and wherein said recessed region comprises the lower surface of said dinnerware within said supporting ridge.

39. The set of claim 38 wherein said pad is sized to fit within said supporting ridge.

40. The set of claim 38 wherein said pad further comprises a recessed groove on its upper surface for stably receiving said supporting ridge.

41. The set of claim 40 wherein said groove is sized to complement said supporting ridge.
